(19) United States
(12) Patent Application Publication
(10) Pub. No.: US 2004/0108888 A1
(43) Pub. Date: Jun. 10, 2004

(54) Constant voltage generating circuit

(75) Inventor: Kenji Nemoto, Sagamihara-shi (JP)

Correspondence Address: Finnegan, Henderson, Farabow,, Garrett & Dunner, L.L.P., 1300 I Street, N.W., Washington, DC, 20005-3315, US

(73) Assignee: ASAHI KASEI MICROSYSTEMS CO., LTD.

(21) Appl. No.: 10/725,436

(22) Filed: Dec. 3, 2003

(30) Foreign Application Priority Data
Dec. 4, 2002 (JP) 2002-352812

(51) Int. Cl. G05F 1/10

(52) U.S. Cl. 327/539

(57) ABSTRACT

It is an object of the present invention to provide a constant voltage generating circuit which can reduce a driving voltage and noise. A resistor R1 is interposed between a pnp transistor PN11 and a base of a pnp transistor PN12. A resistor R2 is connected to a current source P11. The voltages at two terminals of a differential amplifier OPI are expressed as follows:

VPIN=VBE11+VR1+VBE12+ . . . +VBE1n

VNIN=VBE21+VBE22+ . . . +VBE2n

Since VPIN=VNIN, VR1=nVBE(1)-nVBE(N)≡nΔVBE. Thus, VOUT=VBE+α′nΔVBE=1.2 V. This eliminates the need for a circuit for reducing the required voltage to 1/n as required in the prior art. Therefore, the present invention serves to reduce the required voltage.

This application claims priority from Japanese Patent Application No. 2002-352812 filed Dec. 4, 2002, which is incorporated hereinto by reference.

### BACKGROUND OF THE INVENTION

1. Field of the Invention

The present invention relates to a constant voltage generating circuit, and in particular, to a constant voltage generating circuit composed of a band gap reference circuit constructed on a semiconductor integrated circuit and which is effective in reducing a driving voltage and noise.

2. Description of the Related Art

FIG. 4 shows a conventionally well-known band gap reference circuit. The principle of the operation of this circuit utilizes the fact that a positive temperature characteristic is exhibited by the difference (ΔVBE) between the base emitter voltage (VBE) at a bipolar transistor PN21 having a negative temperature characteristic and the VBE at a bipolar transistor PN11 having a different emitter area (that is, N times as large as that of the bipolar transistor PN21). Thus, Formula 1 is realized in a circuit so as to obtain a flat temperature characteristic.

$$V O U T = α Δ V B E + V B E = α \frac{κ T}{q} ln ( N ) + V B E ≅ 1.2 V \qquad ( 1 )$$

κ: Boltzman constant

q: electron load

T: temperature

α: 1+R2/R1

If the ratio of the area of the bipolar transistor PN21 to the area of the bipolar transistor PN11 is about 1:8, α (the voltage gain of a differential amplifier OP1) is about 13.

In view of the voltage gain of the differential amplifier OP1, since a PNP bipolar transistor is connected to the differential amplifier OP1 via a diode, the impedance between VSS and an emitter is low. Furthermore, an emitter terminal is considered to be substantially grounded, so that the differential amplifier is equivalent to an amplifying circuit having input resistance R1 and feedback resistance R2. Accordingly, the gain is (R1+R2)/R1=1+R2/R1=α. Given that noise from the differential amplifying circuit OP1 in input equivalent is defined as Vn, the noise characteristic is about αVn in output equivalent. Likewise, the offset voltage at the differential amplifier OP1 in input equivalent is a times in output equivalent.

For example, the circuits shown in FIGS. 5 and 6 are known to reduce noise (refer to, for example, Japanese Patent Application Laying-open No. 8-44449(1996)). The circuits in FIGS. 5 and 6 differ from each other in that one of them uses PNP bipolar transistors, while the other uses NPN bipolar transistors but their essential operations are equivalent to each other. The operations will be described below with reference to FIG. 6.

NPN transistors (NP11 to NP1n, NP21 to NP2n) having different emitter areas (in the present example, the ratio of the areas is N:1) are connected to two input terminals (+, −) of the differential amplifier OP1 via diodes. Moreover, nNPN transistors are connected in series. Then, a potential difference ΔVBE occurs per stage, so that with the n NPN transistors, a potential difference nΔVBE occurs between the both ends of R1. If PMOS FETs (P1, P2) have an equal W (channel width)/L (channel length) size, an equal current flows through the respective series NPN bipolar transistors. A voltage VOUT is expressed as follows:

VOUT=αnΔVBE+nVBE=n(αΔVBE+VBE)≅1.2 nV (2)

If this output is reduced to 1/n, a voltage of 1.2 V is obtained as in the case with the circuit in FIG. 4. In this case, α is almost equal to the a in FIG. 4.

The noise from the differential amplifier OP1 in input equivalent increases by a factor of a as in the case with the circuit in FIG. 4. Furthermore, an input/output gain is equivalent to that of the circuit in FIG. 4. Accordingly, if the output is multiplied by 1/n to obtain a voltage of 1.2V, the noise characteristicis 1/n compared to the circuit in FIG. 4. The use of the circuit in FIG. 6 reduces noise compared to the circuit in FIG. 4.

Similarly, another bandgap circuit is known to reduce noise (refer to, for example, FIGS. 1 to 3 in U.S. Pat. No. 5,796,244).

As described above, the circuits shown in FIGS. 5 and 6 are considered to be constant voltage generating circuits having a reduced noise characteristic. However, in this case, bipolar transistors must be stacked, and a voltage of (1.2×n) V must be generated and then multiplied by 1/n to obtain a voltage of 1.2 V. In this case, the circuit must be operated with a power supply voltage of (1.2×n) V or higher. Disadvantageously, it is difficult to simultaneously achieve a reduced voltage operation and reduced noise.

Furthermore, with a circuit such as the one described in U.S. Pat. No. 5,796,244, no feedback is provided by an output stage (a circuit detecting nΔVBE does not act as a feedback circuit). Consequently, changes in environment may preclude accurate outputs from being obtained.

Thus, the present invention is directed to providing a constant voltage generating circuit that solves the above problems.

### SUMMARY OF THE INVENTION

The present invention provides a constant voltage generating circuit comprising a group of first bipolar transistors including n (an integer; 2≦n) first bipolar transistors, a group of second bipolar transistors including n second bipolar transistors each having a larger emitter area than the first bipolar transistor, differential voltage generating means for generating a differential voltage between a voltage equal to a sum of base emitter voltages of the n first bipolar transistors and a sum of base emitter voltages of the n second bipolar transistors, and voltage amplification adding means for amplifying the differential voltage and adding the amplified voltage to the base emitter voltage of one of the group of second bipolar transistors to output a constant voltage independent of temperature.

In the constant voltage generating circuit according to the present invention, the differential voltage generating means includes a differential amplifier, and an offset voltage at the differential amplifier in input equivalent has a primary temperature characteristic.

The present invention also provides a constant voltage generating circuit comprising a group of first bipolar transistors including n (an integer; 2≦n) first bipolar transistors, a group of second bipolar transistors including n second bipolar transistors each having a larger emitter area than the first bipolar transistor, differential voltage generating means for generating a differential voltage between a voltage equal to a sum of base emitter voltages of the n first bipolar transistors and a sum of base emitter voltages of the n second bipolar transistors, and voltage amplification adding means including a differential amplifier in which an offset voltage in input equivalent has a primary temperature characteristic, the voltage amplification adding means amplifying the differential voltage and adding the amplified voltage to the sum of the base emitter voltages of the group of second bipolar transistors to output a constant voltage independent of temperature.

The present invention also provides a constant voltage generating circuit comprising a group of first pnp transistors including n (an integer; 2≦n) first pnp transistors, a collector of each of the first pnp transistors being grounded, a base of a first of the group of first pnp transistors being grounded, a base of a k (an integer; 2≦n)-th of the group of first pnp transistors being connected to an emitter of a (k−1)-th of the group of first pnp transistors; a group of second pnp transistors including n second pnp transistors each having a larger emitter area than the first pnp transistor, a collector of each of the group of second pnp transistors being grounded, a base of a first of the group of second pnp transistors being grounded, a collector of each of the group of second pnp transistors being grounded, a base of a k-th of the group of second pnp transistors except a second of the group of second pnp transistors being connected to an emitter of a (k−1)-th of the group of second pnp transistors; current sources connected to the respective emitters of the group of first pnp transistors and the respective emitters of the group of second pnp transistors except the first of the group of second pnp transistors to supply currents to the respective pnp transistors of the groups of first and second pnp transistors, two resistors being connected in series between the emitter of the first of the group of second pnp transistors and the corresponding power source, a connection point between the two resistors being connected to the base of the second of the group of second pnp transistors; and current control means including a first input terminal to which the emitter of an n-th of the first pnp transistors and a second input terminal to which the emitter of an n-th of the second pnp transistors, the current control means controlling currents from the current sources by outputting a control signal that controls the currents from the current sources so that a potential at the first input terminal and a potential at the second input terminal are the same.

The present invention also provides a constant voltage generating circuit comprising a group of first npn transistors including n (an integer; 2≦n) first npn transistors, a base and a collector of each of the first npn transistors being connected together, an emitter of a first of the group of first npn transistors being grounded, an emitter of a k (an integer; 2≦k≦n)-th of the first npn transistors being connected to a collector of a (k−1)-th of the first npn transistors; a group of second npn transistors including n second npn transistors each having a larger emitter area than the first npn transistor, a base and a collector of each of the second npn transistors being connected together, an emitter of a first of the second npn transistors being grounded, an emitter of a k (an integer; 2≦k≦n)-th of the second npn transistors except a second of the second npn transistors being connected to a collector of a (k−1)-th of the second npn transistors; current sources connected to the collector of an n-th of the first npn transistors and the collector of an n-th the second npn transistors to supply currents to the respective npn transistors of the groups of first and second npn transistors, the first of the second npn transistors being connected to the corresponding current source via two resistors connected in series, a connection point between the two resistors being connected to the emitter of the second of the group of second npn transistors; and current control means including a first input terminal to which the collector of the n-th of the first npn transistors and a second input terminal to which the collector of the n-th of the second npn transistors, the current control means controlling currents from the current sources by outputting a control signal that controls the currents from the current sources so that a potential at the first input terminal and a potential at the second input terminal are the same.

The present invention also provides a constant voltage generating circuit comprising a group of first pnp transistors including n (an integer; 2≦n) first pnp transistors, a collector of each of the first pnp transistors being grounded, abase of a first of the first pnp transistors being grounded, a base of a k (an integer; 2≦k≦n)-th of the first pnp transistors being connected to an emitter of a (k−1)-th of the first pnp transistors; a group of second pnp transistors including n second pnp transistors each having a larger emitter area than the first pnp transistor, an collector of each of the second pnp transistors being grounded, a base of a first of the second pnp transistors being grounded, abase of a k-th of the second pnp transistors being connected to an emitter of a (k−1)-th of the second pnp transistors; current sources connected to the respective emitters of the group of first pnp transistors and the respective emitters of the group of second pnp transistors except an n-th of the group of second pnp transistors to supply currents to the respective pnp transistors of the groups of first and second pnp transistors, two resistors being connected in series between the emitter of the n-th of the second pnp transistors and the corresponding power source; and current control means including a first input terminal to which the emitter of an n-th of the first pnp transistors, a second input terminal to which a connection point between the two resistors connected in series is connected, and a differential amplifier, the current control means controlling currents from the current sources by outputting a control signal that controls the currents from the current sources so that a potential at the first input terminal and a potential at the second input terminal are the same, an offset voltage at the differential amplifier in input equivalent having a primary temperature characteristic.

The present invention also provides a constant voltage generating circuit comprising a group of first npn transistors including n (an integer; 2≦n) first npn transistors, a base and a collector of each of the first npn transistors being connected together, an emitter of a first of the first npn transistors being grounded, an emitter of a k (an integer; 2≦k≦n)-th of the first npn transistors being connected to a collector of a (k−1)-th of the first npn transistors; a group of second npn transistors including n second npn transistors each having a larger emitter area than the first npn transistor, a base and a collector of each of the second npn transistors being connected together, an emitter of a first of the second npn transistors being grounded, an emitter of a k (an integer; 2≦k≦n)-th of the second npn transistors being connected to a collector of a (k−1)-th of the second npn transistors; a current source connected to the collector of an n-th of the group of first npn transistors to supply a current to each of the groups of first and second npn transistors, two resistors being connected in series between the current source and an n-th of the second npn transistors; and current control means comprising a first input terminal including a differential amplifier in which an offset voltage in input equivalent has a primary temperature characteristic, the n-th of the first npn transistors being connected to the first input terminal, and a second input terminal to which a connection point between the two resistors connected in series is connected, the current control means controlling a current from the current source by outputting a control signal that controls the current from the current source so that a potential at the first input terminal and a potential at the second input terminal are the same.

In the constant voltage generating circuit according to the present invention, the differential amplifier has a differential pair including a first npn transistor and a second npn transistor having a larger emitter area than the first npn transistor, and a current source that supplies a current to the differential pair. The differential pair includes a first and second input terminals, the first input terminal is a base of the first npn transistor, and the second input terminal is a base of the second npn transistor. An emitter of the first npn transistor is connected to the current source, and an emitter of the second npn transistor is connected to the current source, the emitter of the first npn transistor being connected to the emitter of the second npn transistor.

In the constant voltage generating circuit according to the present invention, the differential amplifier further has a group of first npn transistors including m (an integer; 1≦m) first npn transistors and a group of second npn transistors including m second npn transistors each having a larger emitter area than the first npn transistor, and a base and a collector of each of the group of first npn transistors are connected together. A collector of k (an integer; 2≦k≦m)-th of the group of first npn transistor is connected to an emitter of a (k−1)-th of the group of first npn transistors, the collector of a first of the group of first npn transistors is connected to the emitter of the group of first npn transistor constituting the differential pair, and the emitter of an m-th of the group of first npn transistors is connected to the current source.

A base and a collector of each of the group of second npn transistors are connected together. A collector of a k (an integer; 2≦k≦m)-th of the group of second npn transistor is connected to an emitter of a (k−1)-th of the group of second npn transistors, the collector of a first of the group of second npn transistors is connected to the emitter of the group of second npn transistor constituting the differential pair, and the emitter of an m-th of the group of second npn transistors is connected to the current source.

As described above, according to the present invention, a constant voltage generating circuit is provided which can reduce a driving voltage and noise.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a circuit diagram showing an embodiment of the present invention;

FIG. 2 is a circuit diagram showing an embodiment of a differential amplifier according to the present invention;

FIG. 3 is a circuit diagram showing another embodiment of the present invention;

FIG. 4 is a circuit diagram of a conventional band gap reference circuit;

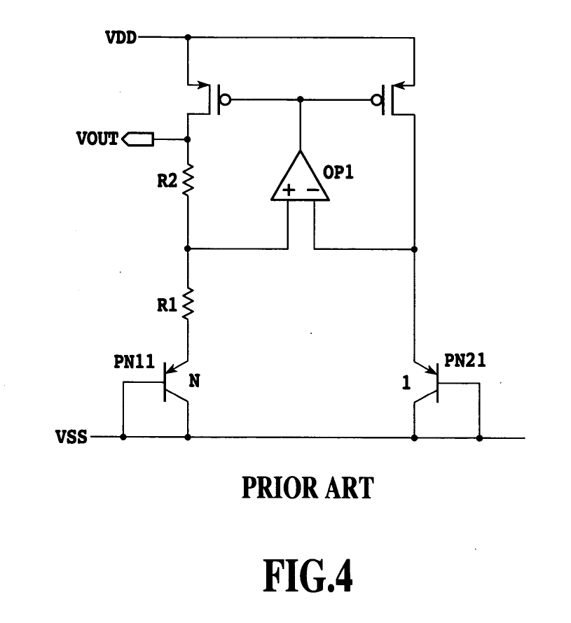

FIG. 5 is a circuit diagram of a conventional band gap reference circuit; and

FIG. 6 is a circuit diagram of a conventional band gap reference circuit.

### DETAILED DESCRIPTION OF PREFERRED EMBODIMENTS

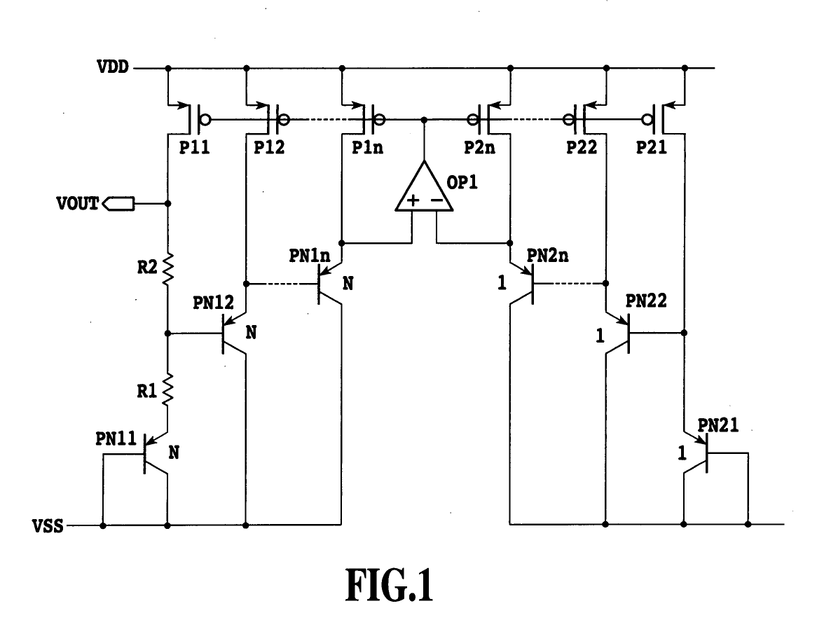

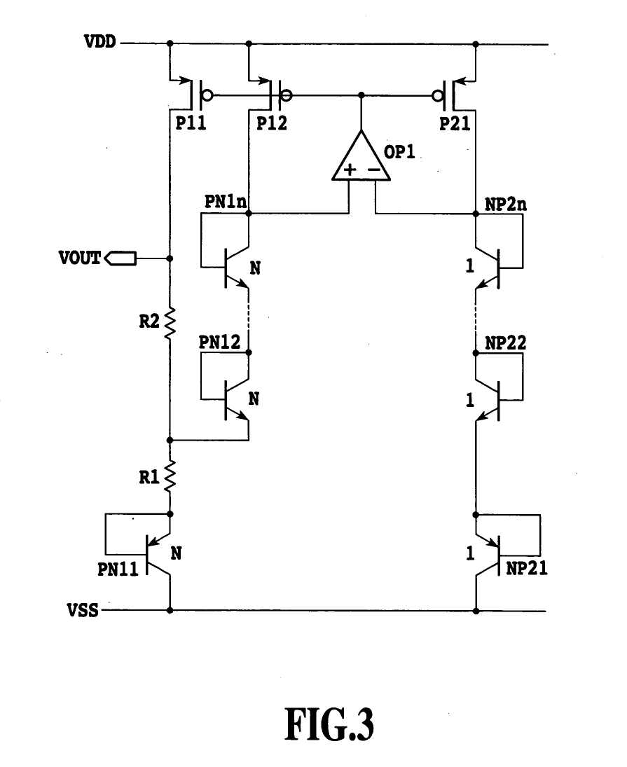

FIG. 1 shows a first embodiment of the present invention (the circuits in FIGS. 1 and 3 differ from each other in that one of them uses pnp bipolar transistors, while the other uses npn bipolar transistors but their essential operations are equivalent to each other).

This constant voltage generating circuit comprises a group of first pnp transistors (PN21 to PN2n) composed of n (an integer; 2≦n) first pnp transistors, a group of second pnp transistors including n second pnp transistors (PN11 to PN1n) each having an emitter area N (an integer; 2≦N)-fold larger than that of the first pnp transistor, current sources (P11 to P1n, P21 to P2n) each of which supplies a current to a corresponding one of the groups of first and second pnp transistors, and a differential amplifier OP1 as current control means for controlling currents from the power sources.

A collector of each of the first pnp transistors is grounded. An emitter of each of the first pnp transistors is connected to the corresponding current source. A base of the first of the group of first pnp transistors PN21 is grounded. A base of the k (an integer; 2≦k≦n)-th of the group of first pnp transistors PN2k is connected to the emitter of the (k−1)-th of the group of first pnp transistors PN2(k−1). A collector of each of the group of second pnp transistors is grounded. An emitter of each of the group of second pnp transistors except the first PN11 of the second pnp transistors is connected to the corresponding current source. A base of the first of the group of second pnp transistors PN11 is grounded. A base of the k-th PN1k of the group of second pnp transistors except the second of the group of second pnp transistors PN12 is connected to the emitter of the (k−1)-th PN1(k-1) of the group of second pnp transistors. Two resistors R1 and R2 are connected in series between the emitter of the first PN11 of the second pnp transistors and the corresponding current source. The connection point between the two resistors connected in series is connected to the base of the second PN12 of the second pnp transistors.

A differential amplifier OP1 comprises a first input terminal (negative input terminal) to which the emitter of the n-th PN2n of the first pnp transistors and a second input terminal (positive input terminal) to which the emitter of the n-th PN1n of the second pnp transistors. The differential amplifier OP1 outputs a control signal that controls the currents from the current sources so that the potential at the first input terminal and the potential at the second input terminal are the same.

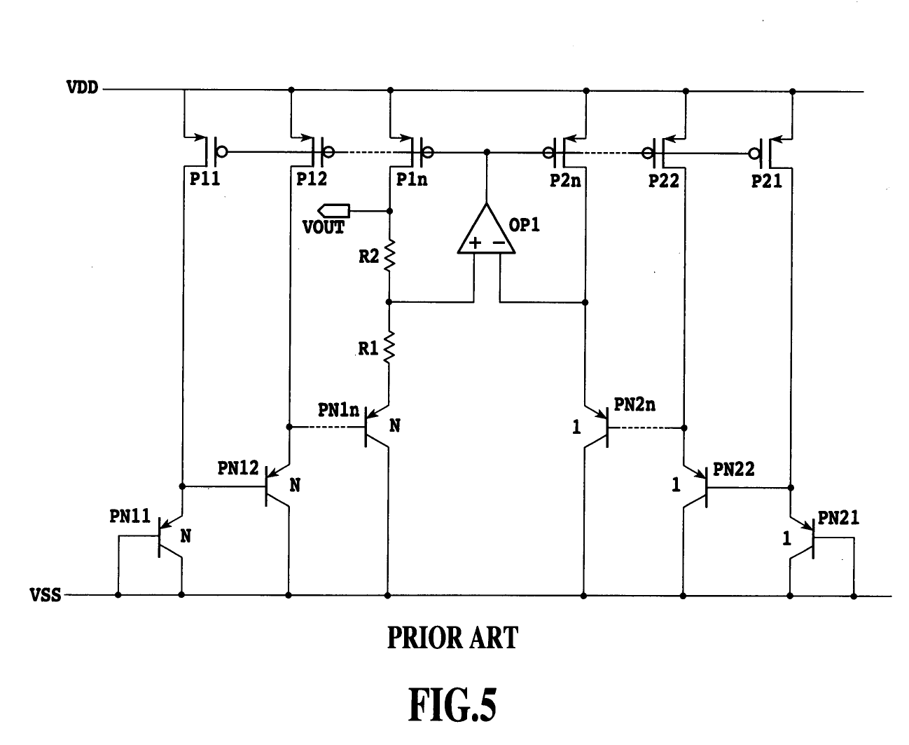

This constant voltage generating circuit differs from the one in FIG. 5 in that the resistor R1 is interposed between the emitter of the second pnp transistor PN11 and the base of the second pnp transistor and that the resistor R2 is connected to the current source P11. The differential amplifier OP1 is used to constitute a feedback system. Accordingly, in operation, the voltage at the positive input terminal of the differential amplifier is the same as the voltage at the negative input terminal.

In this case, the voltages at the respective terminals are expressed as follows:

VPIN=VBE11+VR1+VBE12+ . . . +VBE1n (3)

VNIN=VBE21+VBE22+ . . . +VBE2n (4)

Since VPIN=VNIN, the following formula is established.

VR1=nVBE(1)−nVBE(N)≡nΔVBE

VBE(N)=VBE11= . . . =VBE1n

VBE(1)=VBE21= . . . =VBE2n (5)

Thus, VOUT is expressed by Formula (6).

VOUT=VBE+α′nΔVBE=1.2 V (6)

This eliminates the need for a circuit for reducing the required voltage to 1/n as required in the prior art. Furthermore, since α′n≅α, α′≅α/n. A voltage gain has a noise characteristic equivalent to that observed after the output from the circuit in FIG. 5 has been reduced to 1/n.

The prior art requires a power voltage of (1.2×n)V+the Von of the PMOS FET (current source P11) or higher. However, the present invention can operate with a power voltage of nVBE+the Von of the PMOS FET (current source P11). Thus, the required voltage is reduced.

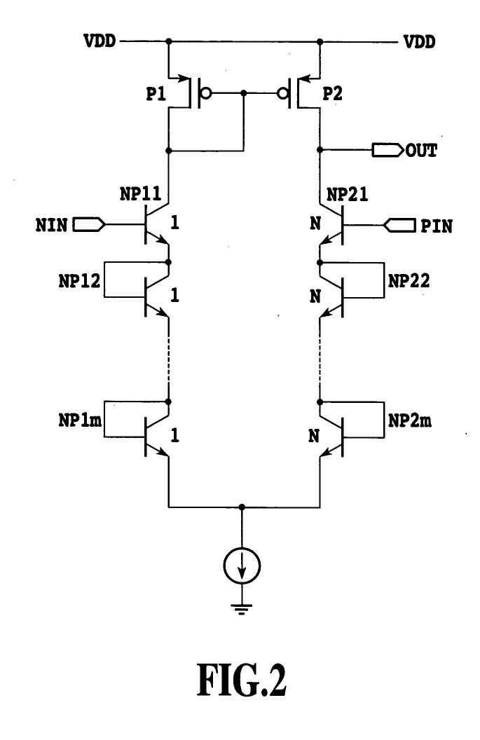

Then, an example of the differential amplifier is shown in FIG. 2.

This differential amplifier comprises a group of first npn transistors (NP11 to NP1m) composed of m (an integer; 2≦m) first npn transistors and a group of second npn transistors (NP21 to NP2m) composed of m second npn transistors each having an emitter area N (an integer; 2≦N)-fold larger than that of the first npn transistor, a differential pair composed of the first of the group of first npn transistors and the first of the group of second npn transistors, and a current source (P1, P2) that supplies a current to the differential pair.

The differential pair comprises a first input terminal NIN (negative input terminal) and a second input terminal PIN (positive input terminal). The first input terminal is a base of the first npn transistor NP11. The second input terminal is a base of the second npn transistor NP21.

A collector of the k (an integer; 2≦k≦m)-th NP1k of the group of first npn transistor is connected to an emitter of the (k−1)-th NP1(k−1) of the group of first npn transistors. A base and a collector of each first npn transistor NP1kare connected together. The emitter of the m-th NP1m of the group of first npn transistors is connected to the current source. A collector of the k (an integer; 2≦k≦m)-th NP2k of the group of second npn transistor is connected to an emitter of the (k−1)-th NP2(k−1) of the group of second npn transistors. A base and a collector of each second npn transistor NP2k are connected together. The emitter of the m-th NP2m of the group of second npn transistors is connected to the current source.

In this differential amplifier is used to constitute a feedback system, currents appearing on the right and left sides of the differential pair are almost the same. Accordingly, the feedback system is stable. In this case, the voltages at the terminals NIN and PIN are considered using, as a reference, the node to which the emitters of the transistors NP1m and NP2m are connected. The following formulae are given.

VNIN=mVBE(1)

VPIN=mVBE(N)

Thus, the potential difference ΔVIN between the voltages VPIN and VNIN is expressed as follows:

ΔVIN=mΔVBE

The potential difference has an offset voltage in input equivalent corresponding to the primary temperature characteristic.

If this differential amplifier is used for the circuit in FIG. 1, the voltage applied to the resistor R1 is nΔVBE+ΔVIN=(n+m)ΔVBE. Thus, VOUT is expressed as follows:

VOUT=VBE+α″(n+m)ΔVBE=1.2 V

Consequently, α″=α/(n+m), thus further reducing the voltage gain.

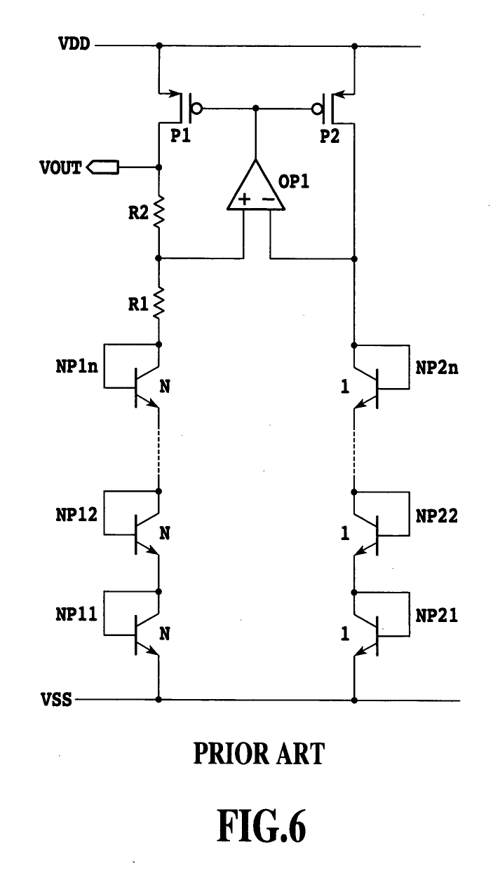

As a result, operations can be preformed with a power voltage equivalent to that used in the embodiment shown in FIG. 1, and the noise characteristic can be improved. Therefore, operations can be performed with a reduced voltage and noise can be reduced, compared to the prior art. If this differential amplifier is used for the circuit in FIG. 3, and in FIGS. 5 and 6, the noise characteristic can also be improved.

As described above, according to the present invention, a constant voltage generating circuit can be provided which can reduce a driving voltage and noise.

The present invention has been described in detail with respect to preferred embodiments, and it will now be apparent from the foregoing to those skilled in the art that changes and modifications may be made without departing from the invention in its broader aspect, and it is the intention, therefore, in the apparent claims to cover all such changes and modifications as fall within the true spirit of the invention.

What is claimed is:

1. A constant voltage generating circuit comprising:
a group of first bipolar transistors including n (an integer; 2≦n) first bipolar transistors;
a group of second bipolar transistors including n second bipolar transistors each having a larger emitter area than the first bipolar transistor;
differential voltage generating means for generating a differential voltage between a voltage equal to a sum of base emitter voltages of said n first bipolar transistors and a sum of base emitter voltages of said n second bipolar transistors; and
voltage amplification adding means for amplifying said differential voltage and adding the amplified voltage to the base emitter voltage of one of said group of second bipolar transistors to output a constant voltage independent of temperature.

2. The constant voltage generating circuit as claimed in claim 1, wherein said differential voltage generating means includes a differential amplifier, and an offset voltage at said differential amplifier in input equivalent has a primary temperature characteristic.

3. A constant voltage generating circuit comprising:
a group of first bipolar transistors including n (an integer; 2≦n) first bipolar transistors;
a group of second bipolar transistors including n second bipolar transistors each having a larger emitter area than the first bipolar transistor;
differential voltage generating means for generating a differential voltage between a voltage equal to a sum of base emitter voltages of said n first bipolar transistors and a sum of base emitter voltages of said n second bipolar transistors; and
voltage amplification adding means including a differential amplifier in which an offset voltage in input equivalent has a primary temperature characteristic, for amplifying said differential voltage and adding the amplified voltage to the sum of the base emitter voltages of said group of second bipolar transistors to output a constant voltage independent of temperature.

4. A constant voltage generating circuit comprising:
a group of first pnp transistors including n (an integer; 2≦n) first pnp transistors, a collector of each of the first pnp transistors being grounded, a base of a first of the group of first pnp transistors being grounded, a base of a k (an integer; 2≦k≦n)-th of the group of first pnp transistors being connected to an emitter of a (k−1)-th of the group of first pnp transistors;
a group of second pnp transistors including n second pnp transistors each having a larger emitter area than the first pnp transistor, an collector of each of the group of second pnp transistors being grounded, a base of a first of the group of second pnp transistors being grounded, a collector of each of the group of second pnp transistors being grounded, a base of a k-th of the group of second pnp transistors except a second of the group of second pnp transistors being connected to an emitter of a (k−1)-th of the group of second pnp transistors;
current sources connected to the respective emitters of said group of first pnp transistors and the respective emitters of said group of second pnp transistors except the first of the group of second pnp transistors to supply currents to the respective pnp transistors of said groups of first and second pnp transistors, two resistors being connected in series between the emitter of said first of the group of second pnp transistors and the corresponding power source, a connection point between the two resistors being connected to the base of said second of the group of second pnp transistors; and
current control means including a first input terminal to which the emitter of an n-th of the first pnp transistors and a second input terminal to which the emitter of an n-th of the second pnp transistors, the current control means controlling currents from the current sources by outputting a control signal that controls the currents from said current sources so that a potential at said first input terminal and a potential at said second input terminal are the same.

5. A constant voltage generating circuit comprising:
a group of first npn transistors including n (an integer; 2≦n) first npn transistors, a base and a collector of each of the first npn transistors being connected together, an emitter of a first of the first npn transistors being grounded, an emitter of a k (an integer; 2≦k≦n)-th of the first npn transistors being connected to a collector of a (k−1)-th of the first npn transistors;
a group of second npn transistors including n second npn transistors each having a larger emitter area than the first npn transistor, a base and a collector of each of said second npn transistors being connected together, an emitter of a first of the second npn transistors being grounded, an emitter of a k (an integer; 2≦k≦n)-th of the second npn transistors except a second of the second npn transistors being connected to a collector of a (k−1)-th of the second npn transistors;
current sources connected to the collector of an n-th of said group of first npn transistors and the collector of an n-th the group of second npn transistors to supply currents to the respective npn transistors of the groups of first and second npn transistors, said first of the second npn transistors being connected to the corresponding current source via two resistors connected in series, a connection point between the two resistors being connected to the emitter of said second of the group of second npn transistors; and
current control means including a first input terminal to which the collector of said n-th of the first npn transistors and a second input terminal to which the collector of said n-th of the second npn transistors, the current control means controlling currents from said current sources by outputting a control signal that controls the currents from said current sources so that a potential at the first input terminal and a potential at the second input terminal are the same.

6. The constant voltage generating circuit as claimed in claim 4 or 5, wherein said differential voltage generating means includes a differential amplifier, and an offset voltage at said differential amplifier in input equivalent has a primary temperature characteristic.

7. A constant voltage generating circuit comprising:
a group of first pnp transistors including n (an integer; 2≦n) first pnp transistors, a collector of each of the first pnp transistors being grounded, a base of a first of the first pnp transistors being grounded, a base of a k (an integer; 2≦k≦n)-th of the first pnp transistors being connected to an emitter of a (k−1)-th of the first pnp transistors;
a group of second pnp transistors including n second pnp transistors each having a larger emitter area than the first pnp transistor, an collector of each of the second pnp transistors being grounded, a base of a first of the second pnp transistors being grounded, a base of a k-th of the second pnp transistors being connected to an emitter of a (k−1)-th of the second pnp transistors;
current sources connected to the respective emitters of said group of first pnp transistors and the respective emitters of said group of second pnp transistors except an n-th of the group of second pnp transistors to supply currents to the respective pnp transistors of said groups of first and second pnp transistors, two resistors being connected in series between the emitter of said n-th of the second pnp transistors and the corresponding power source; and
current control means including a first input terminal to which the emitter of an n-th of the first pnp transistors, a second input terminal to which a connection point between said two resistors connected in series is connected, and a differential amplifier, the current control means controlling currents from said current sources by outputting a control signal that controls the currents from said current sources so that a potential at said first input terminal and a potential at said second input terminal are the same, an offset voltage at the differential amplifier in input equivalent having a primary temperature characteristic.

8. A constant voltage generating circuit comprising:
a group of first npn transistors including n (an integer; 2≦n) first npn transistors, a base and a collector of each of the first npn transistors being connected together, an emitter of a first of the first npn transistors being grounded, an emitter of a k (an integer; 2≦k≦n)-th of the first npn transistors being connected to a collector of a (k−1)-th of the first npn transistors;
a group of second npn transistors including n second npn transistors each having a larger emitter area than the first npn transistor, a base and a collector of each of the second npn transistors being connected together, an emitter of a first of the second npn transistors being grounded, an emitter of a k (an integer; 2≦k≦n)-th of the second npn transistors being connected to a collector of a (k−1)-th of the second npn transistors;
a current source connected to the collector of an n-th of the group of first npn transistors to supply a current to each of the groups of first and second npn transistors, two resistors being connected in series between the current source and an n-th of the second npn transistors; and
current control means comprising a first input terminal including a differential amplifier in which an offset voltage in input equivalent has a primary temperature characteristic, the n-th of the first npn transistors being connected to the first input terminal, and a second input terminal to which a connection point between said two resistors connected in series is connected, the current control means controlling a current from said current source by outputting a control signal that controls the current from said current source so that a potential at said first input terminal and a potential at said second input terminal are the same.

9. The constant voltage generating circuit as claimed in any of claims 4 or 5, wherein said differential voltage generating means includes a differential amplifier, and an offset voltage at said differential amplifier in input equivalent has a primary temperature characteristic,
wherein said differential amplifier has a differential pair including a first npn transistor and a second npn transistor having a larger emitter area than the first npn transistor, and a current source that supplies a current to said differential pair,
wherein said differential pair includes a first and second input terminals, said first input terminal is a base of said first npn transistor, and said second input terminal is a base of said second npn transistor, and
wherein an emitter of said first npn transistor is connected to said current source, and an emitter of said second npn transistor is connected to said current source, the emitter of said first npn transistor being connected to the emitter of said second npn transistor.

10. The constant voltage generating circuit as claimed in any of claims 7 or 8, wherein said differential amplifier has a differential pair including a first npn transistor and a second npn transistor having a larger emitter area than the first npn transistor, and a current source that supplies a current to said differential pair,
wherein said differential pair includes a first and second input terminals, said first input terminal is a base of said first npn transistor, and said second input terminal is a base of said second npn transistor, and
wherein an emitter of said first npn transistor is connected to said current source, and an emitter of said second npn transistor is connected to said current source, the emitter of said first npn transistor being connected to the emitter of said second npn transistor.

11. The constant voltage generating circuit as claimed in claim 7 or 8, wherein said differential amplifier has a differential pair including a first npn transistor and a second npn transistor having a larger emitter area than the first npn transistor, and a current source that supplies a current to said differential pair, and said differential amplifier has a group of first npn transistors including m (an integer; 1≦m) first npn transistors and a group of second npn transistors including m second npn transistors each having a larger emitter area than the first npn transistor,
wherein said differential pair includes a first and second input terminals, said first input terminal is a base of said first npn transistor, and said second input terminal is a base of said second npn transistor, and
wherein an emitter of said first npn transistor is connected to said current source, and an emitter of said second npn transistor is connected to said current source, the emitter of said first npn transistor being connected to the emitter of said second npn transistor,
wherein a base and a collector of each of said group of first npn transistors are connected together, a collector of k (an integer; 2≦k≦m)-th of the group of first npn transistor is connected to an emitter of a (k−1)-th of the group of first npn transistors, the collector of a first of said group of first npn transistors is connected to the emitter of the first npn transistor constituting said differential pair, and the emitter of an m-th of said group of first npn transistors is connected to said current source, and
wherein a base and a collector of each of said group of second npn transistors are connected together, a collector of a k (an integer; 2≦k≦m)-th of the group of second npn transistor is connected to an emitter of a (k−1)-th of the group of second npn transistors, the collector of a first of said group of second npn transistors is connected to the emitter of the second npn transistor constituting the differential pair, and the emitter of an m-th of said group of second npn transistors is connected to said current source.
